(19) United States
(12) Patent Application Publication
(10) Pub. No.: US 2016/0261226 A1
(43) Pub. Date: Sep. 8, 2016

(54) PORTABLE SOLAR POWER GENERATION DEVICES FOR PERMANENT OR TEMPORARY INSTALLATIONS AND METHODS THEREOF

(71) Applicant: Instant Solar LLC, Fincastle, VA (US)

(72) Inventors: James William Hamilton, Fincastle, VA (US); David Cary Webster, Blue Ridge, VA (US)

(21) Appl. No.: 15/063,122

(22) Filed: Mar. 7, 2016

Related U.S. Application Data
(60) Provisional application No. 62/129,122, filed on Mar. 6, 2015.

(51) Int. Cl. H02S 20/32; H02S 10/40; H02S 40/38; H02J 7/35

(52) U.S. Cl. CPC H02S 20/32; H02J 7/355; H02S 10/40; H02S 40/38

(57) ABSTRACT

A portable solar power generation device includes an adjustable solar array apparatus and a power and control block apparatus. The adjustable solar array apparatus includes a base structure, a solar tracking adjustment device extending out from a base structure, an array support structure connected to the solar tracking adjustment device, and a plurality of solar panels connected to a surface of the array support structure a plurality of solar panels connected to a surface of the array support structure. The array support structure extends along a first plane and has at least one hinged section. The hinged section at least has a first position where the hinged section extends along the first plane and a second position where the hinged section is pivoted away from the first plane. Two or more of base structure, the solar tracking adjustment device, or the array support structure are adjustable between a transport configuration and an operational configuration, the transport configuration is smaller than the operational configuration. The power and control block apparatus is coupled to each of the plurality of solar panels and configured to be capable of transforming DC electricity from the plurality of solar panels into AC electricity.

This application claims the benefit of U.S. Provisional Patent Application Ser. No. 62/129,122, filed Mar. 6, 2015, which is hereby incorporated by reference in its entirety.

### FIELD

This technology generally relates to solar power devices and methods, and more particularly to portable solar power generation devices for permanent or temporary installations and methods thereof.

### BACKGROUND

Basically, solar power is the conversion of sunlight into electric current using the photovoltaic effect through the use of devices, such as photovoltaic solar panels and inverters. This generated electric current is often used as either a primary or secondary source of power for many small and medium-sized applications. As improvements in solar conversion technologies continue to be made, the demand for solar power generation systems continues to grow.

Unfortunately, even with these ongoing improvements to the solar conversion technologies, practical issues relating to the transport and installation of these solar power generation systems is costly and inefficient. As a result, despite the growing demand for solar power this inability to provide systems which can be easily transported and installed has had a negative impact on their implementation.

### SUMMARY

A portable solar power generation device includes an adjustable solar array apparatus and a power and control block apparatus. The adjustable solar array apparatus includes a base structure, a solar tracking adjustment device extending out from a base structure, an array support structure connected to the solar tracking adjustment device, and a plurality of solar panels connected to a surface of the array support structure a plurality of solar panels connected to a surface of the array support structure. The array support structure extends along a first plane and has at least one hinged section. The hinged section at least has a first position where the hinged section extends along the first plane and a second position where the hinged section is pivoted away from the first plane. Two or more of base structure, the solar tracking adjustment device, or the array support structure are adjustable between a transport configuration and an operational configuration, the transport configuration is smaller than the operational configuration. The power and control block apparatus is coupled to each of the plurality of solar panels and configured to be capable of transforming DC electricity from the plurality of solar panels into AC electricity.

A method for making a portable solar power generation device includes forming an adjustable solar array apparatus and a power and control block apparatus. The adjustable solar array apparatus includes a base structure, a solar tracking adjustment device extending out from a base structure, an array support structure connected to the solar tracking adjustment device, and a plurality of solar panels connected to a surface of the array support structure a plurality of solar panels connected to a surface of the array support structure. The array support structure extends along a first plane and has at least one hinged section. The hinged section at least has a first position where the hinged section extends along the first plane and a second position where the hinged section is pivoted away from the first plane. Two or more of base structure, the solar tracking adjustment device, or the array support structure are adjustable between a transport configuration and an operational configuration, the transport configuration is smaller than the operational configuration. The power and control block apparatus is coupled to each of the plurality of solar panels and configured to be capable of transforming DC electricity from the plurality of solar panels into AC electricity.

This technology provides a portable solar power generation device in an integrated platform that optimizes delivery, installation, operation and component protection for solar electric generation to make low-cost, reliable electricity. Additionally, the design of this technology makes installing solar power generation quick and simple. This technology has engineered-out a majority of the soft costs of solar power generation installations and created safeguards for sensitive components against environmental threats, including electromagnetic pulse, to ensure the optimum continuous operation of the portable solar power generation devices. Further this technology is designed to be compatible with any existing utility grid and also to be able to operate separately from the existing utility grid.

### BRIEF DESCRIPTION OF THE DRAWINGS

FIG. 1 is a side view of an example of a portable solar power generation device;

FIG. 2 is a top view of an adjustable base structure for the example of the solar power generation device illustrated in FIG. 1 with two of the adjustable legs in an extended installation position and two of the adjustable legs in a retracted transport position;

FIG. 3 is an end view of the example of the portable solar power generation device illustrated in FIG. 1 with the opposing hinged sections of the array support structure with the plurality of solar panels in pivoted position for transport;

FIG. 4 is a side view of the example of the portable solar power generation device illustrated in FIG. 1 with another set of opposing hinged sections of the array support structure with the plurality of solar panels in pivoted position for transport;

FIG. 5 is a top view of a plurality of solar panels on the array support structure of the example of the portable solar power generation device illustrated in FIG. 1;

FIG. 6 is a side view of a portion of a hinged section on the array support structure of the example of the portable solar power generation device illustrated in FIG. 1;

FIG. 7 is a side view of a portion of an adjustable leg of the example of the portable solar power generation device illustrated in FIG. 1;

FIG. 8 is a bottom view of the adjustable leg illustrated in FIG. 7;

FIGS. 9A-9D are diagrams of altitude axis axle array extensions and detachable connections for the addition of more solar panels to the array support structure of the example of the portable solar power generation device illustrated in FIG. 1;

FIG. 10 is a block diagram of an example of an outer motor control cabinet in a power and control block apparatus of the example of the portable solar power generation device illustrated in FIG. 1;

FIGS. 11A-11E are diagrams of isolation blocks that fasten the EMP shielding around to protect the power and control block apparatus;

FIG. 12A is a diagram of an example of a power and control block apparatus for the example of the portable solar power generation device illustrated in FIG. 1;

FIG. 12B is a diagram of an example of an optional batter cabinet for the example of the portable solar power generation device illustrated in FIG. 1

FIGS. 13A-13C are diagrams of an example of an optional wheel kit for the portable solar power generation device illustrated in FIGS. 1-12B;

FIG. 14 is diagram of an example of an installation of the portable solar power generation device; and

FIG. 15 is a diagram of an example of rings, tabs, stops and switches for the solar tracking adjustment device to manage position limits.

### DETAILED DESCRIPTION

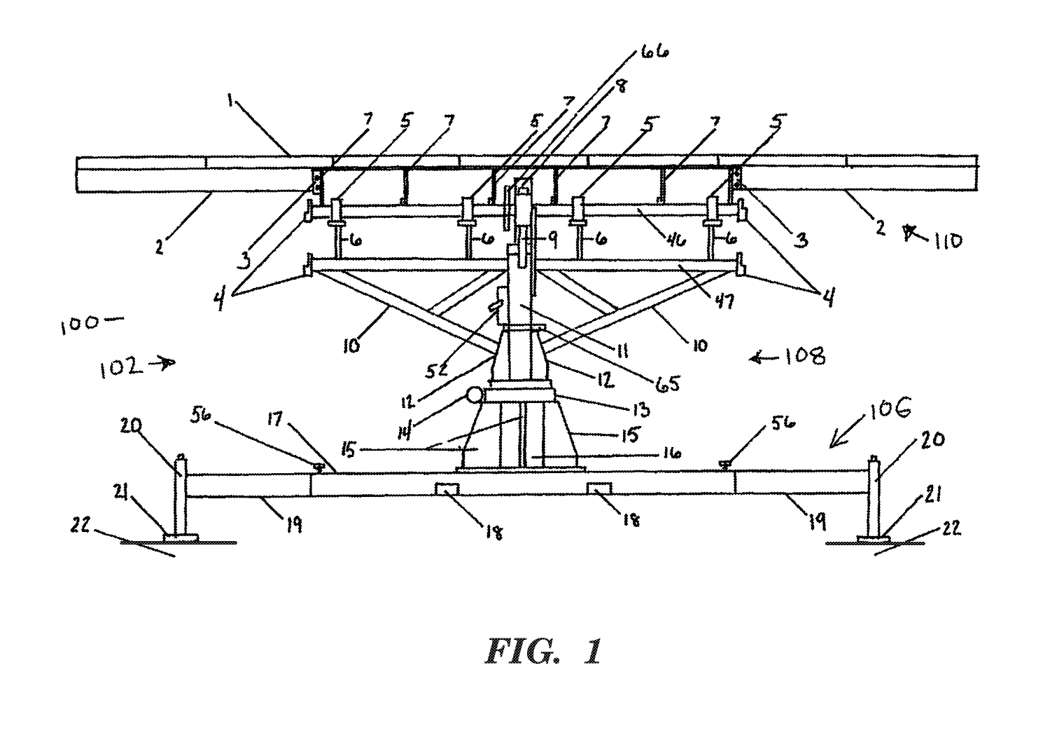

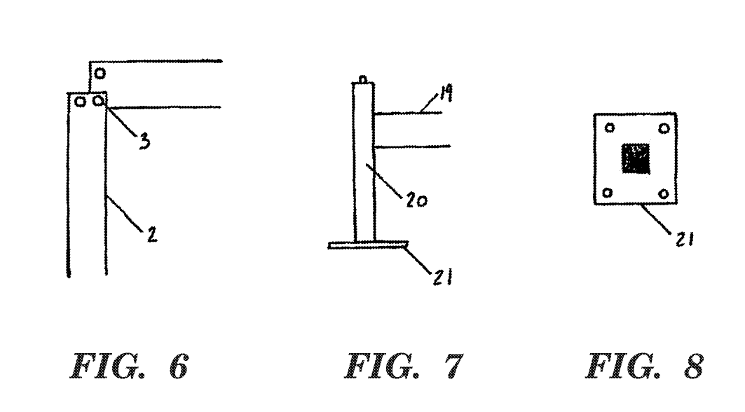

An example of a portable solar power generation device 100 is illustrated in FIGS. 1-15. The portable solar power generation device 100 includes an adjustable solar array apparatus 102 and a power and control block apparatus 104, although the portable solar power generation device 100 may have other types and/or numbers of other systems, apparatuses, devices, components, and/or other elements in other configurations. This technology provides a number of advantages including providing a portable solar power generation device in an integrated platform that optimizes delivery, installation, operation and component protection for solar electric generation to make low-cost reliable electricity.

The adjustable solar array apparatus 102 includes a base structure 106, a solar tracking adjustment device 108, and an array support structure 110 for an array of solar panels 1, although the adjustable solar array apparatus 102 may have other types and/or numbers of other systems, apparatuses, devices, components, and/or other elements in other configurations.

Referring more specifically to FIGS. 1-4, 6-8, and 14, the base structure 106 includes an array base platform 17, telescoping adjustable outriggers 19, adjustable outrigger legs 20, and multipoint fastening outrigger feet 21 with outrigger ground fasteners 22, although the base structure 106 may have other types and/or numbers of other systems, apparatuses, devices, components, and/or other elements in other configurations.

The array base platform 17 comprises a structure that provides a supporting base for the portable solar power generation device 100 and extends along a first plane, although other types of supporting structures in other configurations could be used. In this particular example, the array base platform 17 also has a pair of passages 18 which extend in, are reinforced at least partially along their length into the array base platform 17, and are spaced at a distance to accommodate receipt of a pair of forks from a forklift truck to facilitate easy movement and positioning for transport and installation of the portable solar power generation device 100, although the reinforced forklift lifting points 18 could be at other locations on the portable solar power generation device 100 and other manners for facilitating movement of the portable solar power generation device 100 could be used.

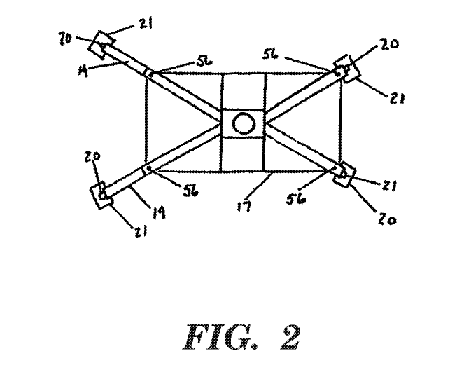

Four telescoping adjustable outriggers 19 are connected to and extend out from the array base platform 17, although other types and/or numbers of adjustable or non-adjustable outriggers may be used. In this particular example, the telescoping adjustable outriggers 19 can be retracted in for transport as illustrated on the right side of FIG. 2 and can be extended out as illustrated in FIG. 1 and on the left side of FIG. 2 to provide the necessary support for the installation of the portable solar power generation device 100. An outrigger position locking device 56 may be adjustably rotated to detachably lock each of the telescoping adjustable outriggers 19 into one of the extended or retracted positions, although other manners for securing the adjustment of the telescoping adjustable outriggers 19 can be used.

One of the adjustable outrigger legs 20 may be connected to an end of each of the telescoping adjustable outriggers 19, although the legs could be connected at other locations and/or other types of supports could be used. A length of each of the adjustable outrigger legs 20 can be changed so that the plane along which the array base platform 17 is level with the ground or other supporting surface.

One of the multipoint fastening outrigger feet 21 may be connected to the end of each of the adjustable outrigger legs 20, although the feet could be connected at other locations and/or other types of supports could be used. Each of the multipoint fastening outrigger feet 21 may be secured to the ground or other supporting surface with one or more of the outrigger ground fasteners 22, such as a screw anchor, helical pier, or concrete reinforced footer with threaded rod by way of example only.

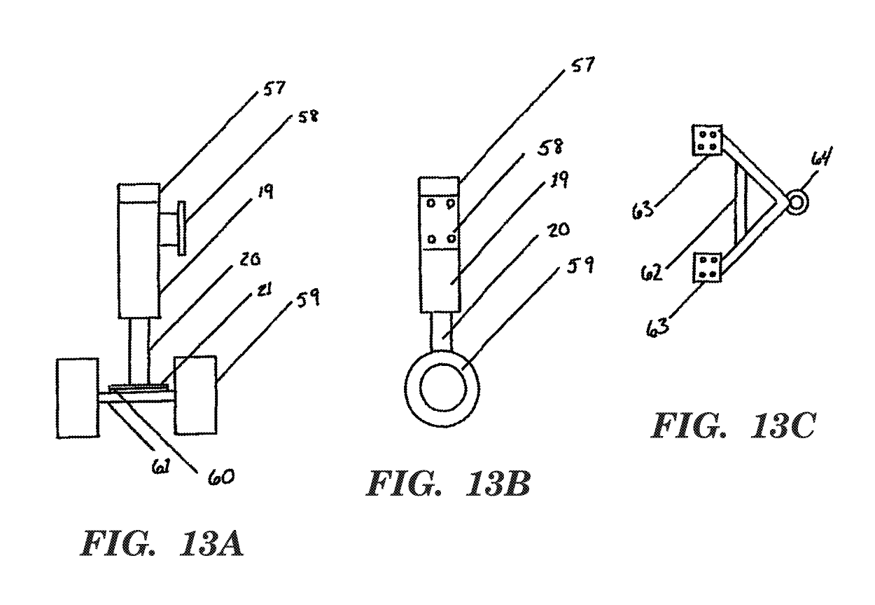

Referring to FIGS. 13A-13C, an example of an optional wheel kit for the portable solar power generation device 100 is illustrated. In this particular example, an outrigger foot height adjustment cover 57 and outrigger mounting plate 58 may be detachably coupled to one or more of the telescoping adjustable outriggers 19, adjustable outrigger legs 20 or the array base platform 17, although other manners for attaching to the array base platform 17, to one or more of the telescoping adjustable outriggers 19, adjustable outrigger legs 20, and/or other parts of the adjustable solar array apparatus 102 may be used. The optional wheel kit makes positioning the array 100 and the power block 104 quicker and easier. The detachable wheel kit can be attached to the outrigger foot 21 or directly to the telescoping outrigger 19 or to the base platforms 17 and 42. The choice of mounting location is determined by the various obstacles that have to be overcome on uneven terrain. An optional axle 61 includes a connection housing that rotatably connects the axle 61 to one of the multipoint fastening outrigger feet 21. Additionally, the axle 61 may have optional off-road wheels or other tires rotatably coupled to each of the ends of the axle 61, although other manners for attaching tires or other wheels may be used. Additionally, an optional wheel kit swivel mount 61 may be coupled between each of the multipoint fastening outrigger feet 21 and the connection housing for the axle 61. Further, as illustrated in FIG. 13C an optional removable steering yoke 62 with a pintel hitch 64 and steering yoke mounting plates 60 may be connected to the wheel kit swivel mount 60 and used to facilitate transport and positioning of the adjustable solar array apparatus 102.

Referring more specifically to FIGS. 1-4 and 9-12, and 14-15, the solar tracking adjustment device 108 is connected to and extends out from the the array base platform 17 of the base structure 106, although the solar tracking adjustment device 108 can be connected in other manners. In this particular example, the solar tracking adjustment device 108 may include mast riser support brackets 15 that extend out from the mast riser 16 which are connected to the array base platform 17 of the base structure 106, although the mast riser 16 can be connected in other manners. The array mast 11 is rotatably seated in an azimuth axis slew gear 13 on an outer circumference of the mast riser 16 that may be engaged to rotate by an azimuth axis slew gear motor 14 to adjust the positioning of the solar panels 1, although other manners for rotatably or non-rotatably connecting the array mast 11 to the array base platform 17 can be used. The array support brackets 10 are secured at one end to the array mast support brackets 12 which extend out from the array mast 11 and are secured at another end to one of a plurality of altitude axis axle horizontal support extensions 47, although the array support brackets 10 can be connected at other locations in other manners.

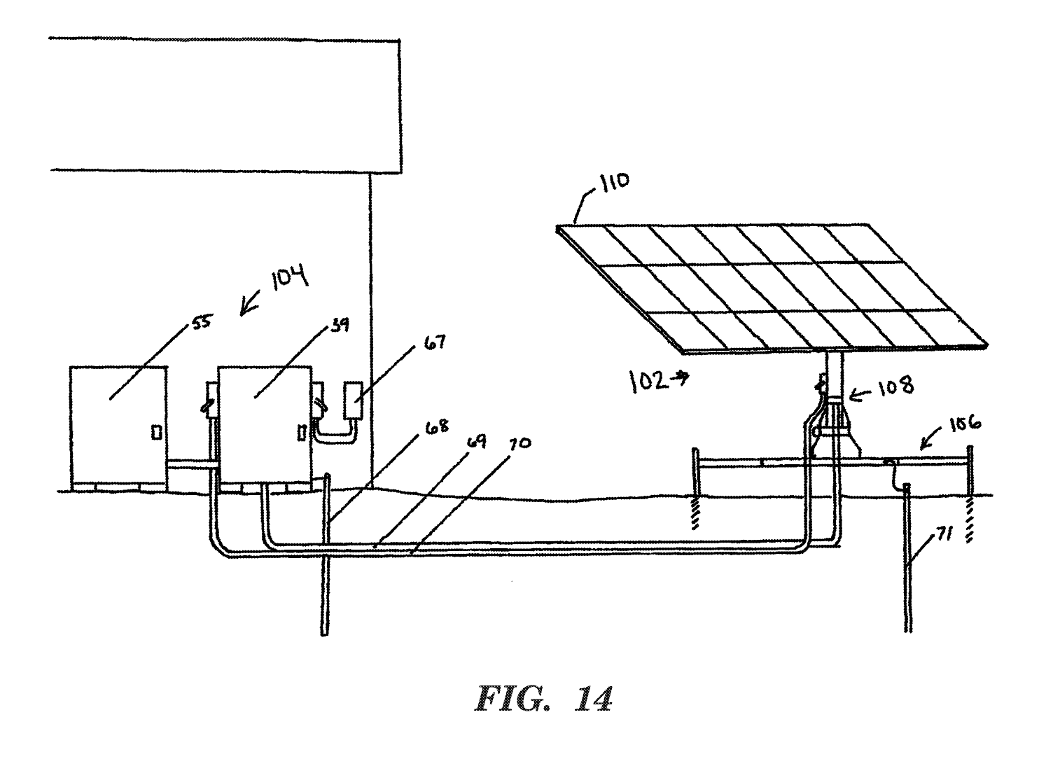

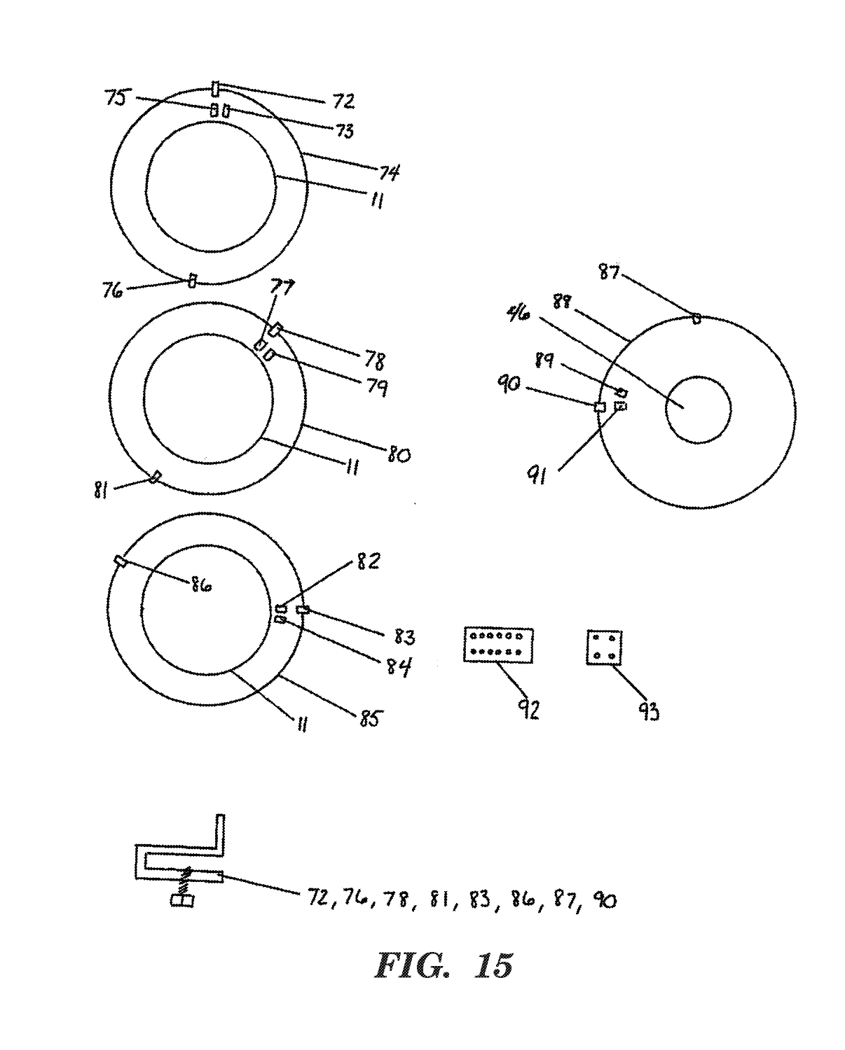

Referring more specifically to FIG. 15, in this particular example one or more rings, such as optional seasonal rings which may comprise a winter proximity ring for azimuth tracking 74, fall/spring proximity ring for azimuth tracking 80, or summer proximity ring for azimuth tracking 85 and/or also an optional altitude tracking ring 88, may be selected and seated on or otherwise installed around at least a portion of the array mast 11 to establish limits for positioning, although other types and/or numbers of devices to establish limits for positioning may be used. Additionally, each of these rings 74, 80, 85, and 88 may have one or more adjustable tabs 72,76, 78, 81, 83, 86, 87, and 90, such as winter start tab for azimuth tracking 72, winter stop tab for azimuth tracking 76, fall/spring start tab for azimuth tracking 78, fall/spring stop tab for azimuth tracking 81, summer start tab for azimuth tracking 83, summer stop tab for azimuth tracking 86, altitude tracking summer tab 87, and altitude tracking winter tab 90, by way of example only, although other types and/or numbers of adjustable or permanent tabs could be used. Further each of these rings 74, 80, 85, and 88 may have one or more switches, such as winter stop proximity switch for azimuth tracking 73, winter start proximity switch for azimuth tracking 75, fall/spring start proximity switch for azimuth tracking 77, fall/spring stop proximity switch for azimuth tracking 79, summer start proximity switch for azimuth tracking 82, summer stop proximity switch for azimuth tracking 84, altitude tracking stop proximity switch 89, and altitude tracking start proximity switch 91, although other types and/or numbers of start and/or stop switches could be used. In this particular example, the azimuth proximity switch plug/connection point on the array side 92 and altitude proximity switch plug/connection point on the array side 93 are connected to the control wires/cable 69, although other types and/or numbers of connections in other configurations may be used. The cable 69 couples to the disconnect box 52 on the array 100 in FIG. 1 and couples to the corresponding power block connection points 94 and 95 within the inner cabinet 36 of the power block 104 shown in FIGS. 10 and 14.

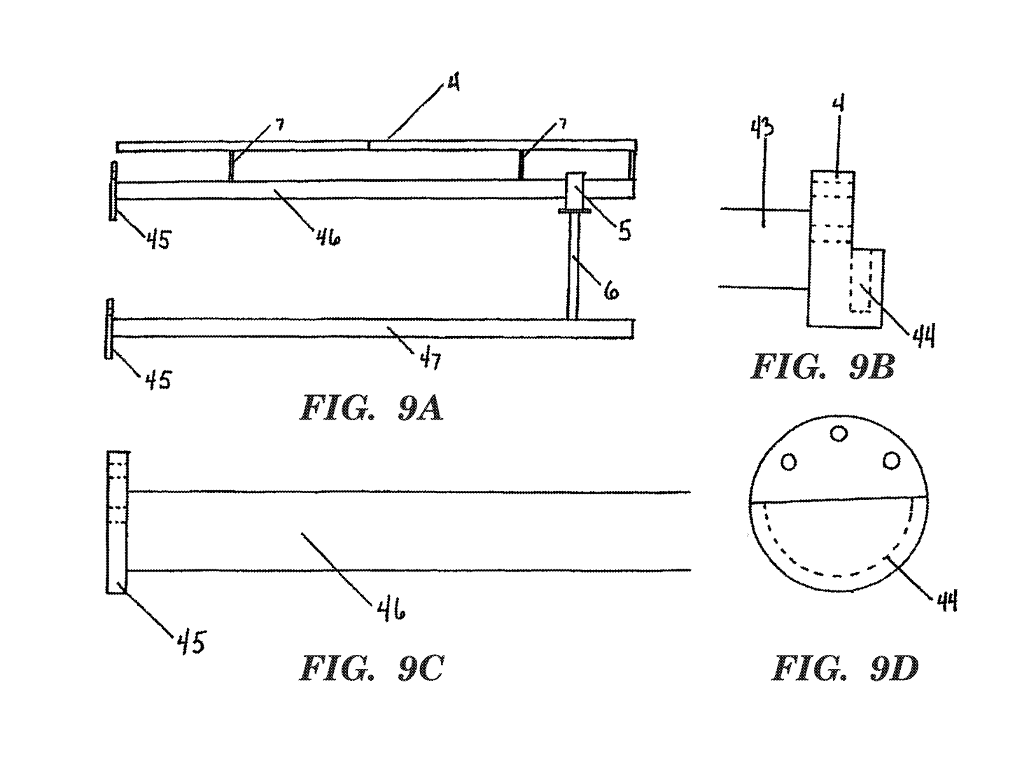

Referring more specifically to FIGS. 1 and 9A-9D, the solar tracking adjustment device 108 may further include a plurality of split pillow block supports 6 that each may be connected at one end to one of the altitude axis axle horizontal support extensions 47 and at the other end to one of a plurality of split pillow blocks 6 which are each seated on one of the plurality of altitude axis axle extensions 46. A coupling bracket locking plate 45 may be connected to the end of one or more of the plurality of the altitude axis axle extensions 46 and the plurality of altitude axis axle horizontal support extensions 47 to allow additional support extensions to be easily added to facilitate having more solar array panels 1 for an installation, although other types and/or manners for providing extension mechanisms may be used. Solar panel bracket supports 7 connect at one end to one of the altitude axis axle extensions 46 and at the other end to support one or more of the solar panels 1, although other manners for supporting the solar panels 1 may be used. As illustrated in FIGS. 9C-9D, altitude axis extension axles 43 may have a coupling bracket receiver 44 at one end that defines a slot that is configured to receive and easily mate with a corresponding portion of one of the coupling bracket locking plates 45 and may optionally be secured together, such as with nuts and bolts by way of example, through corresponding openings in the receiver 44 and plate 45 when mated and aligned, although other manners for securing the connection can be used.

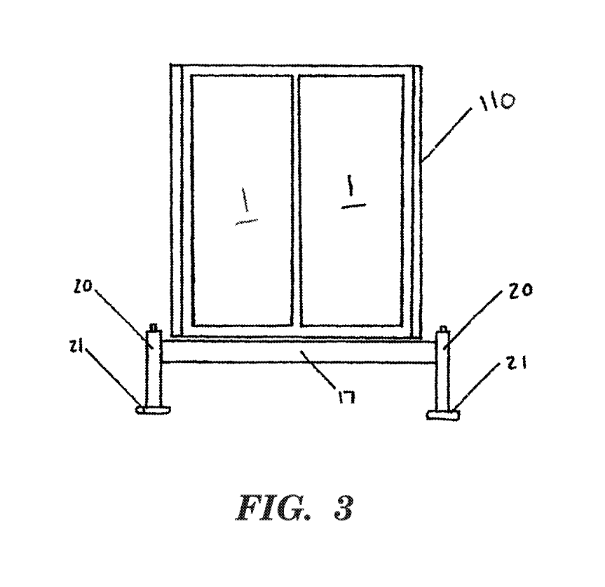

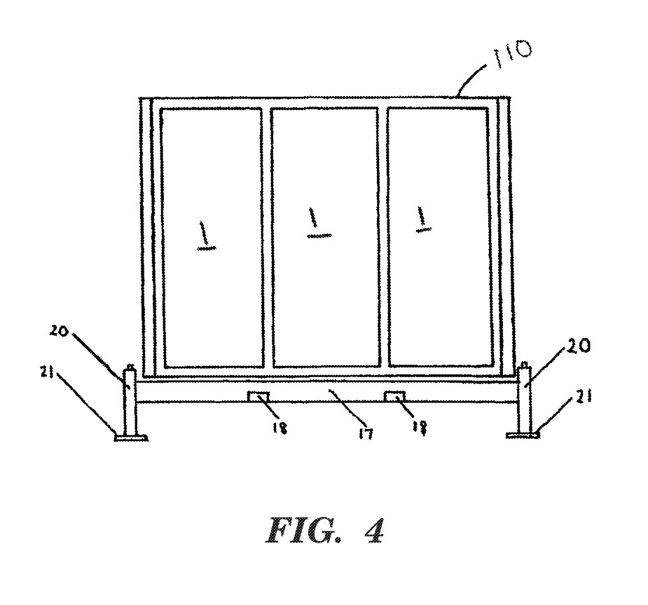

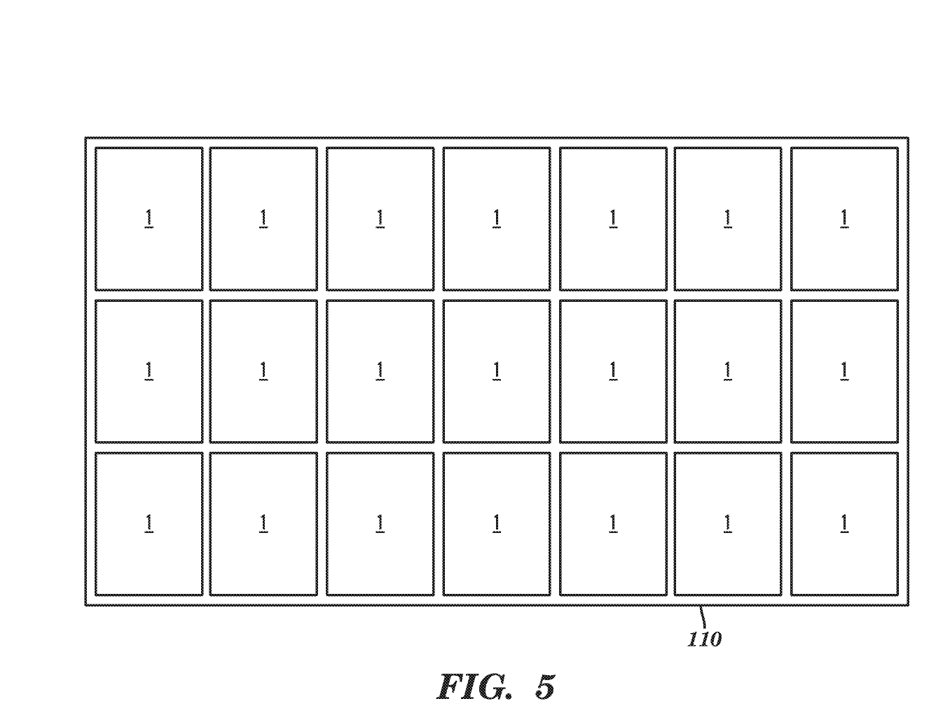

Referring more specifically to FIGS. 1, 3-5, and 14, an example of the array support structure 110 for the array of solar panels 1 is illustrated. The array support structure 110 can accommodate any size solar panel, but to achieve the lowest cost economics in this particular example higher wattage solar panels 1 are used, although other types could be used. In this particular example, the number of solar panels 1 typically ranges from 13 to 33 to retain portability. Additionally, in this particular example the solar panels 1 ranged from 255 watts to 365 watts, although solar panels with other wattages could be used. The array support structure 110 that supports the solar panels 1 in the array (as shown by way of example in FIG. 5) may comprise hinged array supports 2 on which solar panels 1 are seated and secured which are pivotally connected by hinges 3 to the axis axle extensions 46 to pivot between an open position as shown by way of example on FIGS. 1, 5 and 14 and closed or folded positions for transport and installation as shown by way of example in FIGS. 3 and 4, although other manners for pivotally connecting the solar panels 1 can be used.

Referring more specifically to FIGS. 10, 11A-11E, 12A-12B and 14, an example of the power and control block apparatus 104 is illustrated. The power and control block apparatus 104 may include a solar operations control apparatus 103 and an optional power storage apparatus 105, although the power and control block apparatus 104 may include other types and/or numbers of other systems, devices, components and/or other elements in other configurations.

Referring more specifically to FIG. 14, the power and control block apparatus 104 may also include a power block connector to a utility/client electric supply breaker box 67, a power block grounding electrode 68, dual axis tracking control wires 69 (which in this particular example comprise a bundled cable of communication and control wires, although other types and/or numbers of connections may be used) an array DC output cable 70, and/or a solar array grounding electrode 71, although the power and control block apparatus 104 may have other types and/or numbers of other systems, apparatuses, devices, components, and/or other elements in other configurations well known to one of ordinary skill in the art. A portion or all of the power and control block apparatus 104 may be attached to the base structure 106 for convenience of shipping, set-up, and/or operation.

Referring more specifically to FIGS. 10, 11A-11E, 12A and 14, the solar operations control apparatus 103 may include an inner motor control cabinet 36, an outer motor control cabinet 37, an isolated inner inverter cabinet 38, an outer control and inverter cabinet 39, power block platform/skids 42, a power block DC disconnect 53, and a power block AC disconnect 54, although the solar operations control apparatus 103 may have other types and/or numbers of other systems, apparatuses, devices, components, and/or other elements in other configurations well known to one of ordinary skill in the art.

The outer control and inverter cabinet 39 is used to house the outer motor control cabinet 37 and the isolated inner inverter cabinet 38, although the cabinet 39 could contain other types and/or numbers of other systems, devices, components and/or other elements in other configurations. Optional power block platform/skids 42 may be used to help secure the position of the outer control and inverter cabinet 39, although other types and/or numbers of supports could be used.

The outer motor control cabinet 37 is used to shield against weather and provide the outer layer of electromagnetic pulse shielding for the inner control cabinet 36, although other types of housing arrangements could be used. The inner motor control cabinet 36 may include gear motor speed controls 25 for adjusting the speed of and/or to control the altitude and azimuth motors (not shown) in cabinet 36 and/or cabinet 38 for the proper tracking of the solar panels 1 of the array with the sun with an optional “soft” start and “soft” stop to prevent jerking motions. The inner motor control cabinet 36 may also include an altitude axis gear motor programmable logic controller 111 configured or other computing device having a memory with programmed instructions for execution by a processor for switching the altitude and/or azimuth motors (not shown) in cabinet 36 and/or cabinet 38 off and on throughout the day/month/year tracking the sun on the north-south axis.

Additionally, the inner motor control cabinet 36 may include an altitude axis gear motor forward contactor 27 for initiating the movement of the array/motor in the forward “north” direction on the north-south axis, an altitude axis gear motor reverse contactor 28 for initiating the movement of the array/motor “south” in the reverse direction on the north-south axis include, an altitude axis gear motor controls 29, an azimuth axis—gear motor, controls to switch from 120v AC to 90v DC and a programmable logic controller 111 that is configured or other computing device having a memory with programmed instructions for execution by a processor to manage and control their operations.

In this particular example, the programmable logic controller 111 may be configured and/or may comprise a computing device with a memory having programmed instructions for execution by a processor for: switching the azimuth motor “off” and “on” throughout the day as the solar panels 1 of the array are adjusted to track the sun from east to west; the azimuth axis gear motor forward contactor 31 for initiating the forward movement of the array/motor from east to west daily beginning at sun rise; azimuth axis—gear motor reverse contactor 32 for initiating the reverse movement of the array/motor from west to east daily after sun set; adjusting the azimuth axis with azimuth axis—gear motor controls 33; and/or for changing 120v AC to 90v DC, although the programmable logic controller 111 may also be configured and/or the computing device may have a memory with programmed instructions for execution by a processor for other types and/or numbers of function and/or operations for controlling and/or managing solar energy collection operations.

The inner motor control cabinet 36 may also include a fuse block 34 with one or more fuses to protect the power and control block apparatus 104, an azimuth proximity switch on the power block side 94 for connection with the solar panels 1 of the array via a cable 69, and/or an altitude proximity switch on the power block side 95 for connection with the solar panels 1 of the array via the cable 69, although inner motor control cabinet 36 may have other types and/or numbers of other systems, devices, components and/or other elements in other configurations.

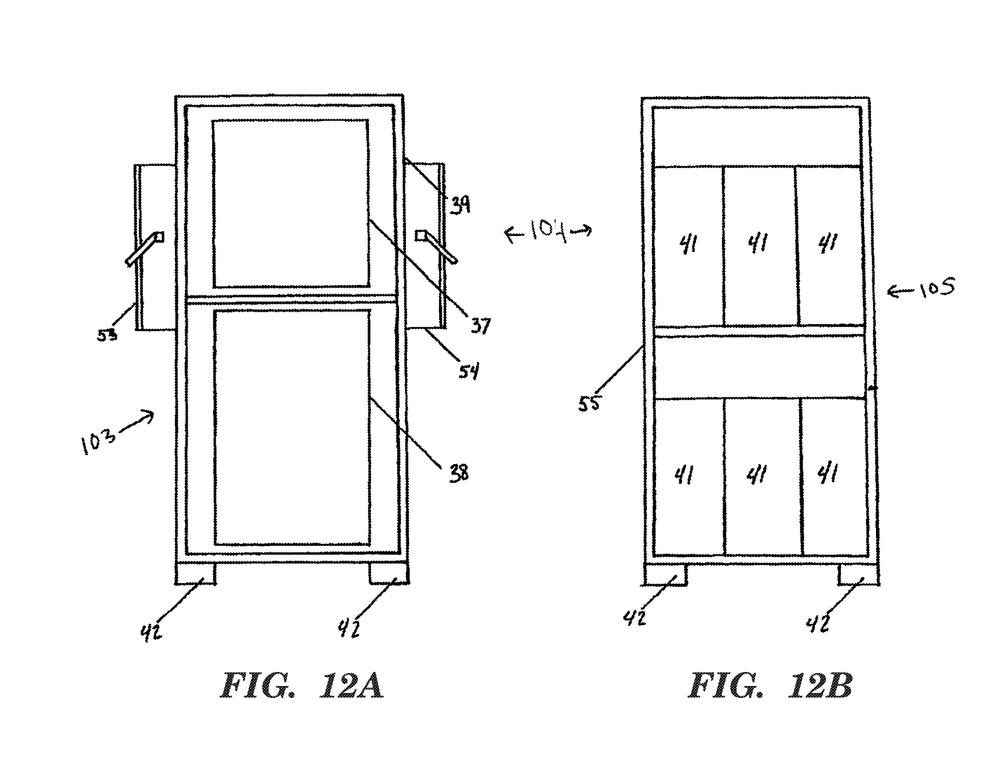

Referring more specifically to FIGS. 10 and 12A, the isolated inner inverter cabinet 38 may be used to protect/shield the inverter, auto transformers and/or other sensitive electronic equipment well known to those of ordinary skill in the art for controlling and/or managing solar energy collection operations from an electromagnetic pulse or other undesired electric charge.

Referring more specifically to FIGS. 12A and 14, the power block DC disconnect 53 may be used to isolate/disconnect DC power cable 70 from the solar panels 1 of the array during maintenance or repair. The power block AC disconnect 54 may be coupled in and used to isolate/disconnect the AC power supply from the power storage apparatus 105 and/or the utility grid during maintenance or repair.

Other equipment that may be contained within the cabinets 36, 37, 38, and/or 39 may include, but is not limited to inverters, production meter(s), charge controllers, programmable logic controllers, contactors, gear motor controls, motor speed controls, voltage controls, fuse block/overload protection and terminal block(s) whose components and their connections and operations for controlling and/or managing solar energy collection operations are well known to one of ordinary skill in the art.

Referring more specifically to FIGS. 12B and 14, the power storage apparatus 105 may include an optional outer battery cabinet 55 with one or more batteries 41 which are coupled to receive and store electricity converted from sunlight by the solar panels 1 of the array and optional power block platform/skids 42 to secure the position of the outer battery cabinet 55, although the power storage apparatus 105 may comprise other types and/or numbers of other systems, devices, components and/or other elements in other configurations. The optional batteries 41 may store the electricity obtained from the converted solar energy for future use. The optional batteries 41 and associated electronic components and connections may be contained within cabinet 55 and coupled between the portable solar generation device 100 and the utility meters and electric infrastructure to integrate the portable solar generation device 100 into the existing electric architecture as shown by way of the example in FIG. 14. By way of example only, for new construction or agricultural applications, such as irrigation where stand-alone electric generation are desired, the utility connection and meter could be eliminated and the portable solar generation device(s) 100 could become the electrical energy source.

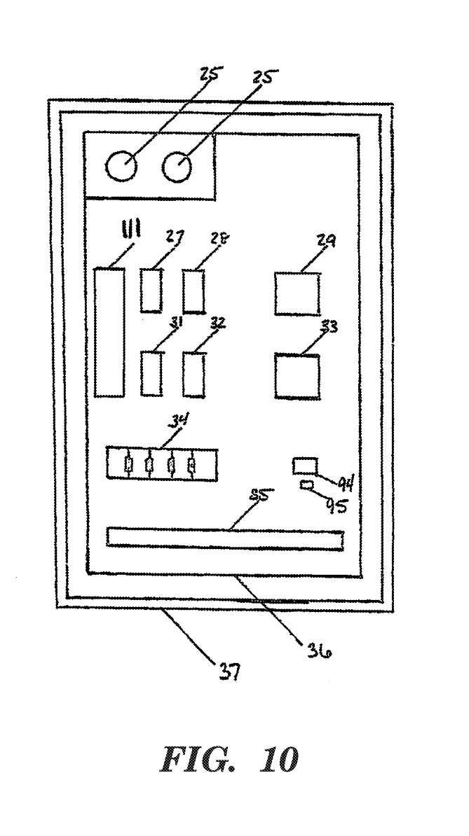

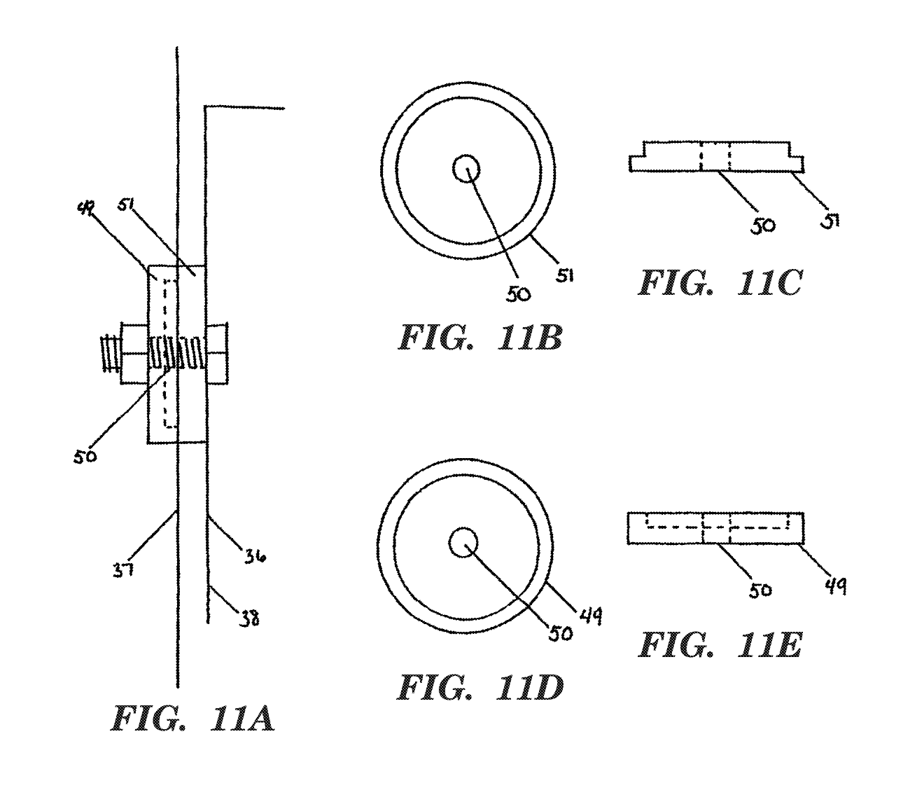

In addition to system lightening protection, all of the electrical components contained in cabinets 36, 37, 38, 39, and/or 55 may be isolated from the exterior housing by use of specialty polymer isolation bushings to provide protection against the effects of electromagnetic pulse from geomagnetic solar storms and/or man-made sources of EMP as shown in FIGS. 11A-11E. Additionally, optional venting (not shown) for cabinets 36, 37, 38, 39, and/or 55 may be used and provided by specially designed materials, surfaces and fine mesh materials.

Referring more specifically to FIGS. 11A-11E, diagrams of isolation blocks that fasten the EMP shielding around to protect electronic components in the cabinets 36, 37, 38, 39, and/or 55 in the power and control block apparatus 104 are illustrated. In this particular example, the female side of isolation bushing 49, a bolt hole through isolation bushing 50, a male side of isolation bushing 51, are located between the gaps between the inner motor control cabinet 36 and the outer motor control cabinet 37 as well as between the inner inverter cabinet 38 and the outer inverter cabinet 39. The bushing 49 provides a gap between the surfaces of the outer motor control cabinet 37 and outer control and inverter cabinet 39 and inner inverter cabinet 38 and outer control and inverter cabinet 39 so the EMP pulse cannot penetrate to the sensitive electronics within the outer motor control cabinet 37 and isolated inner inverter cabinet 38. With this example of the design for a “metal box within a metal box” with isolation material between the cabinets 36, 37, 38, and/or 39, prevents conduction of an electrical charge thus blocking any electromagnetic pulse from reaching any sensitive electronic equipment in the power and control block apparatus 104.

Solar tracking of the solar arrays 1 of the portable solar power generation device 100 may also be provided by motors and proximity switches mounted on the array of solar panels 1 and controlled by the programmable logic controller 111 and a series of contactors for solar tracking as is well known to one of ordinary skill in the art. In this particular example, the programmable logic controller 111 may control 180 pairs of contactors to provide dual-axis tracking for 180 solar arrays 1. By centralizing the solar tracking in the power and control block apparatus 104, the cost of tracking controls are minimized and spread across the number of arrays being controlled which lowers the cost per Kwh of electricity produced.

An example of a method for making and installing the portable solar power generation device 100 will now be described with reference to FIGS. 1-15. In this particular example, the portable solar power generation device 100 can be transported without the solar panels 1 attached, although in this particular example the solar panels 1 are already attached for quick installation. In this particular example, the base structure 106, the solar tracking adjustment device 108, and the array support structure 110 are each adjustable between a transport configuration and an operational configuration where the transport configuration is smaller than the operational configuration to facilitate portability.

By way of example only, the configuration of the portable solar power generation device 100 can be adjusted or folded into a box configuration with the telescoping outriggers 19 and outrigger legs 20 of the base structure 106 retracted, the extensions 43 disconnected from the extensions 46 and 47 in the solar tracking adjustment device 108, and the hinged array supports 2 pivoted to a folded position for the array support structure 110, although other adjustments to reduce the dimensions for each of the base structure 106, the solar tracking adjustment device 108, and/or the array support structure 110 may be used. The base structure 106 with reinforced forklift passages 18 facilitates ease of handling for shipping, installation and redeployment of the portable solar generation device 100. The optional wheel kit with wheels 59 may be used to facilitate moving the portable solar generation device 100 with the optional yoke 62 to and at the desired site, although other manners of transporting and/or positioning the portable solar generation device 100 may be used.

Once the portable solar generation device 100 is at the desired location, the telescoping outriggers 19 and outrigger legs 20 of the base structure 106 can be extended as needed, the extensions 43 may be attached to the extensions 46 and 47 in the solar tracking adjustment device 108, and the hinged array supports 2 may be pivoted to an open position for the array support structure 110, although other aspects of the base structure 106, the solar tracking adjustment device 108, and/or the array support structure 110 may be used and extended. In this particular example, the outriggers 19 may extend an additional three feet and with the legs 20 may adjust to variable ground height differentials to create a stable level operating platform. Permanent installations may use fasteners 22, such as screw anchors, helical piers or reinforced concrete footers as anchor points for securing the feet 21 of legs 20 to the ground or to other supporting surface. The outriggers 19 and/or legs 20 may be extend to lift the portable solar generation device 100 off the trailer for ease of installation by increasing the height of the outriggers 19 and/or legs 20 so the trailer can be pulled from underneath the array. When the portable solar generation device 100 is delivered via a trailer, the portable solar generation device 100 may also remain attached to the trailer as a mobile generating system or it can be attached to the ground as a permanent source for electric generation

As noted earlier, if a larger array is desired, extensions 43 may be added to the opposing sides of the extensions 46 and 47 at the desired site. By way of example only, each extension 43 is configured to be installed in minutes and accommodates six additional solar panels 1 (on each side) so an array with two extensions becomes a 33 panel array in a 3×11 panel configuration. As an example, using a 365 watt solar panel, a 21-solar panel array has a solar generating surface area of 19′4″×23′ and a nameplate generating capacity of 7.66 KW. Likewise, a 33-solar panel array has a solar generating surface area of 19′4″×36′2″ and a nameplate generating capacity of 12.04 KW. In this particular example, the foot print of the array skid is roughly 6′8″ or 7′ 8″×10′ 8″. This small modular design unfolds and expands at the desired site to provide utility scale electric generating economics. Multiple portable solar power generation devices 100 could be transported to the site and easily coupled together and connected to the power and control block apparatus 104 to further expand the power generation capacity.

Examples of this technology provide portable solar power generation devices 100 with a dual axis tracking array that increases electricity production by an average of 34% vs. a properly positioned fixed array within the continental United States. The dual axis tracking provides up to 57% more solar electric generation than fixed position arrays in the northern regions of North America.

Other examples of this technology provide portable solar power generation devices 100 with a single axis tracking array that increases electricity production by an average of 27% vs. a properly positioned fixed array within the continental United States. Over the 20+ year life of the portable solar power generation device 100, the increased electricity production from a dual-axis tracking system is the most economical option for maximizing electricity generation per dollar invested and per square foot of available surface area. The term “dual axis tracking” refers to automated continuous adjustment of the array's altitude axis (north-south pitch alignment toward the sun) and automated continuous adjustment of the array's azimuth axis (east to west alignment of the array following the movement of the sun across the sky daily). The array returns to face the point of the sun's rise in the east after sunset. The term “single axis tracking” refers to automated continuous adjustment of the array's azimuth axis (east to west alignment of the array to the movement of the sun across the sky daily). The array returns to face the point of the sun's rise in the east after sunset.

In this particular example, this transport configuration of 6′8″ or 7′ 8″×10′ 8″ for the portable solar power generation device 100 facilitates portability, although other dimensions could be used. With this example of the sizing, four of the portable solar power generation devices 100 may fit on a conventional flatbed truck or a single array can be shipped with its power and control block apparatus 104 on a trailer pulled behind a personal vehicle to a desired site. As another example, a 40′ shipping container could accommodate three of these examples of the portable solar power generation devices 100 along with the supporting power and control block apparatus 104 for a 36.14 KW solar generating power station in that shipping container.

Accordingly, as illustrated and described by way of the examples herein, this technology provides a portable solar power generation device in an integrated platform that optimizes delivery, installation, operation and component protection for solar electric generation to make low-cost, reliable electricity. With this technology, the portable solar power generation device is designed to be skid/frame mounted for ease of transport to the job site for installation. Additionally, the design of this technology allows for both easy movement of a portable solar generation device to another installation site and/or for the permanent installation of the portable solar power generation devices at a particular site.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A portable solar power generation device comprising:
an adjustable solar array apparatus that comprises:
a base structure;
a solar tracking adjustment device extending out from a base structure;
an array support structure connected to the solar tracking adjustment device, the array support structure extends along a first plane and has at least one hinged section, the hinged section at least has a first position where the hinged section extends along the first plane and a second position where the hinged section is pivoted away from the first plane; and
a plurality of solar panels connected to a surface of the array support structure;
wherein two or more of the base structure, the solar tracking adjustment device, or the array support structure are adjustable between a transport configuration and an operational configuration, the transport configuration is smaller than the operational configuration;
a power and control block apparatus coupled to each of the plurality of solar panels and configured to be capable of transforming DC electricity from the plurality of solar panels into AC electricity.

2. The device as set forth in claim 1 wherein the base structure further comprises:
a plurality of adjustable legs having at least an extended installation position and a retracted transport position; and
at least a pair of spaced apart forklift openings extending into the base structure, wherein the base structure along the forklift openings is reinforced with one or more materials.

3. The device as set forth in claim 2 further comprising a wheel kit comprising:
a wheel mount device that detachably couples to the base structure; and
a wheel rotatably mounted to the wheel mount device.

4. The device as set forth in claim 1 wherein the solar tracking adjustment device further comprises:
an adjustable array mast structure connected between the base structure and the array support structure;
an altitude adjustment device coupled to the adjustable array mast structure and configured to be capable of adjusting the altitude pitch angle of the array support structure with the plurality of solar panels; and
an azimuth adjustment device coupled to the adjustable array mast structure and configured to be capable of adjusting the azimuth angle of the array support structure with the plurality of solar panels.

5. The device as set forth in claim 1 wherein the array support structure comprise at least two pairs of opposing hinged sections, each of the hinged sections having at least the first position where the hinged section extends along the first plane and the second position where the hinged section is pivoted away from the first plane.

6. The device as set forth in claim 1 wherein the power and control block apparatus further comprises one or more batteries configured to be capable of storing the DC electricity from the plurality of solar panels.

7. A method for making a portable solar power generation device, the method comprising:
forming an adjustable solar array structure comprising:
a base structure;
a solar tracking adjustment device extending out from a base structure;
an array support structure connected to the solar tracking adjustment device, the array support structure extends along a first plane and has at least one hinged section, the hinged section at least has a first position where the hinged section extends along the first plane and a second position where the hinged section is pivoted away from the first plane; and
a plurality of solar panels connected to a surface of the array support structure;
wherein two or more of the base structure, the solar tracking adjustment device, or the array support structure are adjustable between a transport configuration and an operational configuration, the transport configuration is smaller than the operational configuration;
coupling a power and control block apparatus to each of the plurality of solar panels and configured to be capable of transforming DC electricity from the plurality of solar panels into AC electricity.

8. The method as set forth in claim 6 wherein the base structure further comprises:
providing a plurality of adjustable legs having at least an extended installation position and a retracted transport position; and
forming at least a pair of spaced apart forklift openings extending into the base structure, wherein the base structure along the forklift openings is reinforced with one or more materials.

9. The method as set forth in claim 8 further comprising a wheel kit comprising:
providing a wheel mount device that detachably couples to the base structure; and
providing a wheel rotatably mounted to the wheel mount device.

10. The method as set forth in claim 7 wherein the solar tracking adjustment device further comprises:
an adjustable array mast structure connected between the base structure and the array support structure;
an altitude adjustment device coupled to the adjustable array mast structure and configured to be capable of adjusting the altitude pitch angle of the array support structure with the plurality of solar panels; and
an azimuth adjustment device coupled to the adjustable array mast structure and configured to be capable of adjusting the azimuth angle of the array support structure with the plurality of solar panels.

11. The method as set forth in claim 7 wherein the array support structure comprise at least two pairs of opposing hinged sections, each of the hinged sections having at least the first position where the hinged section extends along the first plane and the second position where the hinged section is pivoted away from the first plane.

12. The method as set forth in claim 7 wherein the power and control block apparatus further comprises one or more batteries configured to be capable of storing the DC electricity from the plurality of solar panels.
